(19) United States
(12) Patent Application Publication
(10) Pub. No.: US 2018/0141012 A1
(43) Pub. Date: May 24, 2018

(54) ON-LOCATION SAND DELIVERY SYSTEM & CONVEYOR AND PROCESS

(71) Applicant: Halliburton Energy Services, Inc., Houston, TX (US)

(72) Inventors: Bryan Chapman Lucas, Duncan, OK (US); Tim H. Hunter, Duncan, OK (US); Calvin L. Stegemoeller, Duncan, OK (US); Bryan John Lewis, Duncan, OK (US); Austin Carl Schaffner, Duncan, OK (US); Jim Basuki Surjaatmadja, Duncan, OK (US)

(21) Appl. No.: 15/563,686

(22) PCT Filed: May 7, 2015
(86) PCT No.: PCT/US2015/029733

§ 371 Date: Oct. 2, 2017

(51) Int. Cl. B01F 15/02; B65G 65/06

(52) U.S. Cl. CPC B01F 15/0235; B65G 65/42; B65G 65/06

(57) ABSTRACT

In accordance with presently disclosed embodiments, systems and methods for using containers, instead of pneumatic transfer, to move bulk material from a transportation unit to a blender receptacle of a blender are provided. A transportation unit may deliver one or more containers of bulk material to the well site, where one or more conveyors may deliver the containers to a location proximate the blender receptacle. A chute may extend from the bottom of each container to route bulk material from the one or more containers directly into the blender receptacle. Since the transportation unit is able to unload the containers of bulk material without pneumatic transfer, the containers may enable a cleaner and more efficient bulk material transfer at the site.

### TECHNICAL FIELD

The present disclosure relates generally to transferring solid or liquid bulk materials for well operations, and more particularly, to an on-location sand delivery system and conveyor for providing bulk materials into a blender.

### BACKGROUND

During the drilling and completion of oil and gas wells, various wellbore treating fluids are used for a number of purposes. For example, high viscosity gels and proppant infused liquids are used to create fractures in oil and gas bearing formations to increase production. High viscosity and high density gels are also used to maintain positive hydrostatic pressure in the well while limiting flow of well fluids into earth formations during installation of completion equipment. High viscosity fluids are used to flow sand into wells during gravel packing operations. The high viscosity fluids are normally produced by mixing dry powder and/or granular materials and agents with water at the well site as they are needed for the particular treatment. Systems for metering and mixing the various materials are normally portable, e.g., skid- or truck-mounted, since they are needed for only short periods of time at a well site.

The powder or granular treating material is normally transported to a well site in a commercial or common carrier tank truck. Once the tank truck and mixing system are at the well site, the dry powder material (bulk material) must be transferred or conveyed from the tank truck into a supply tank for metering into a blender as needed. The bulk material is usually transferred from the tank truck pneumatically. More specifically, the bulk material is blown pneumatically from the tank truck into an on-location storage/delivery system (e.g., silo). The storage/delivery system may then deliver the bulk material onto a conveyor or into a hopper, which meters the bulk material through a chute into a blender tub.

The pneumatic conveying process used to deliver bulk material from the tank truck can be a time-consuming process. In addition, some well locations are arranged without a large amount of space to accommodate tank trucks, such that only a limited number of available tank trucks can be positioned to pneumatically fill the storage/delivery system at a given time. Accordingly, the pneumatic conveying process can lead to dead time of equipment usage and relatively high detention costs or demurrage costs associated with the tank trucks, hoses, and related equipment that are on-location during this time.

Furthermore, during the pneumatic conveying process, the bulk material is moved from the tank truck to the storage/delivery system in a turbulent manner, leading to large amounts of dust and noise generation. The air used for conveying the material must be vented from the storage tank and typically carries an undesirable amount of dust with it. Attempts to control dust during the conveying process typically involve the rig up and use of auxiliary equipment, such as a dust collector and duct work, adding cost and operator time to the material handling operations.

In addition, traditional material handling systems can have several transfer points between the outlets of multiple storage/delivery systems and a blender. These transfer points often have to be shrouded and ventilated to prevent an undesirable release of dust into the environment. Further, after the dust has been captured using the dust collectors and ventilation systems, additional steps are needed to dispose of the dust.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic block diagram of a bulk material handling system suitable for delivering a container of bulk additive materials to a blender receptacle (e.g., blender tub or hopper) for mixing with liquids to form well treating fluids at a well site, in accordance with one embodiment of the present disclosure;

FIG. 2 is a schematic block diagram of a bulk material handling system suitable for delivering two containers of the same or different bulk additive materials simultaneously to a blender receptacle (e.g., blender tub or hopper) for mixing with liquids to form well treating fluids at a well site, in accordance with another embodiment of the present disclosure;

FIG. 3 is a schematic view of a two-container bulk delivery system in a side-by-side orientation over a blender and an associated material control system connected thereto, in accordance with the embodiment illustrated in FIG. 2; and

FIG. 4 is a top view of the two side-by-side disposed containers around the blender receptacle of FIG. 2, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for managing bulk material (e.g., bulk solid or liquid material used on location) efficiently at a well site. More specifically, the disclosed embodiments are directed to systems and methods for efficiently moving bulk material into a blender receptacle associated with a blender on location, which could be into a blender hopper or directly into a mixing tub of the blender. The present disclosure may include a system that utilizes multiple containers (e.g., pre-filled containers or filled on location) holding bulk material and positioned via a conveyor to transfer bulk material from the containers directly into the blender receptacle. The disclosed techniques may be used to efficiently handle any desirable bulk material having a solid or liquid constituency including, but not limited to, sand, proppant, gel particulate, dry-gel particulate, liquid additives, and others.

In currently existing on-site bulk material handling applications, bulk material (e.g., sand, proppant, gel particulate, or dry-gel particulate) may be used during the formation of treatment fluids. In such applications, the bulk material is preferably transferred between transportation units, storage tanks, blenders, and other on-site components. The bulk material is often transferred pneumatically using pressurized air flows to provide the bulk material, for example, from a transportation unit (e.g., tank truck) to a storage/delivery system (e.g., silo). The bulk material may later be moved from the storage/delivery system to a hopper on a blender truck. A sand screw, chute, or other metering mechanism disposed in the hopper then meters the bulk material into a mixing tub of the blender, where the bulk material is mixed with other materials (e.g., water, fluids, chemicals, etc.). In some instances, the bulk material can be transferred pneumatically from a transportation unit into a storage tank on the blender truck.

Pneumatic transfer methods are generally selected due to the simplicity of the process. However, certain inherent inefficiencies are associated with the above-described pneumatic transfer of bulk material at a well site. First, blowing the bulk material pneumatically from a transportation unit to a storage/delivery system is a time consuming process, taking at least an hour to empty a single truck. Although the pneumatic process of blowing bulk material into a storage container can be accomplished prior to using the bulk material in blender operations, the long amount of time spent pneumatically transferring the bulk material to the storage/delivery system can lead to high equipment/detention costs. Detention costs are associated with the transportation equipment (e.g., tank trucks) being positioned on location for a period of time. In some instances, the equipment on location may be arranged so that accessibility to storage/delivery systems is limited for transportation units being used to pneumatically fill the storage/delivery systems. As a result, a large amount of time can be wasted by trucks waiting to move into position as other trucks are unloading bulk material, or trucks waiting for the material already in a storage bin to be used to make room for the next load of material.

In addition, the pneumatic transfer of bulk material tends to require a large amount of air to move the material through the system. As this volume of air vents to the atmosphere, fine dust particles are entrained and released. It is undesirable for this dust to be released into the atmosphere. Accordingly, existing systems employ dust control techniques that often utilize large pieces of additional equipment, separate power supplies, and complicated setups. In addition, the pneumatic transfer process, as well as the systems used to control dust, can lead to an undesirable level of noise produced during bulk material transfer.

The bulk material container systems disclosed herein are designed to address and eliminate these shortcomings. The presently disclosed techniques use a plurality of linearly arranged containers, instead of a pneumatic transfer process, to move the bulk material from a transportation unit(s) to the blender receptacle (e.g., blender hopper or mixer). The transportation unit may deliver one or more containers of bulk material to the well site, where the containers may then be aligned linearly and/or side-by-side over the blender receptacle. The containers may be positioned such that one container is disposed immediately above the receptacle of the blender or such that two or more containers are arranged side-by-side each other immediately above the receptacle and the bulk material is dispensed directly from the container(s) into the receptacle (e.g., via a chute, hatch, opening, etc.). A gravity feed outlet or chute may extend from the bottom of the containers, to route bulk material from the one or more containers directly into the blender receptacle. Since the transportation unit is able to unload the linearly/side-by-side arranged containers of bulk material without pneumatic transfer, the containers may be used to more efficiently transfer bulk material to the blender.

The container systems and methods described herein may reduce detention costs associated with bulk material handling at the location, since the efficient filling process may enable quicker offloading of each tank truck, as compared to those that rely on pneumatic transfer. In addition, by eliminating the pneumatic conveyance process entirely, the linear/side-by-side arranged container system may reduce the amount of dust generated at the location, as well as the noise levels associated with the bulk material transfer. The reduced dust generation may allow a reduction in the size of various dust control equipment used to ventilate the material handling system, leading to a reduction in overall cost, footprint, and rig-up time of the dust control equipment.

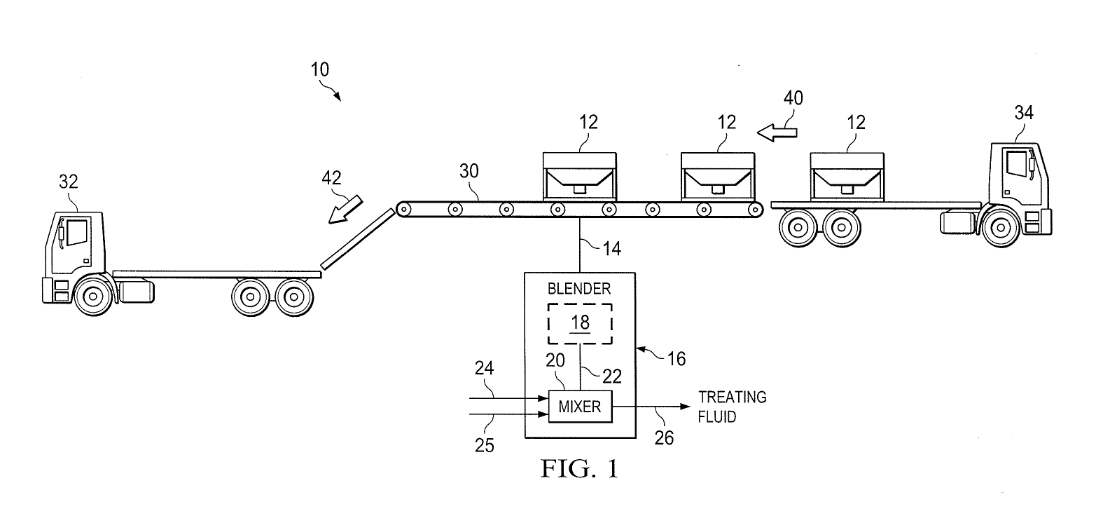

Turning now to the drawings, FIG. 1 is a block diagram of a bulk material handling system 10. The system 10 includes a plurality of containers 12, each designed for holding a quantity of bulk material (e.g., solid or liquid treating material). The containers 12 may utilize a gravity feed to provide a controlled, i.e., metered, flow of bulk material at an outlet 14. The outlet 14 may be a chute that conveys the bulk material from the containers 12 to a blender 16. As illustrated, the blender 16 may include a hopper 18 and a mixer 20 (e.g., mixing compartment). The blender 16 may also include a metering mechanism 22 for providing a controlled, i.e., metered, flow of bulk material from the hopper 18 to the mixer 20. However, in other embodiments the blender 16 may not include the hopper 18, such that the outlet 14 from the containers 12 may provide bulk material directly into the mixer 20.

Water and other additives may be supplied to the mixer 20 (e.g., mixing compartment) through inlets 24 and 25, respectively. The bulk material and liquid additives may be mixed in the mixer 20 to produce (at an outlet 26) a fracturing fluid, gel, cement slurry, drilling mud, or any other fluid mixture for use on location. The outlet 26 may be coupled to a pump for conveying the treating fluid into a well (e.g., a hydrocarbon recovery well) for a treating process. It should be noted that the disclosed container 12 may be utilized to provide bulk material for use in a variety of treating processes. For example, the disclosed systems and methods may be utilized to provide proppant materials into fracture treatments performed on a hydrocarbon recovery well. In other embodiments, the disclosed techniques may be used to provide other materials (e.g., non-proppant) for diversions, conductor-frac applications, cement mixing, drilling mud mixing, and other fluid mixing applications.

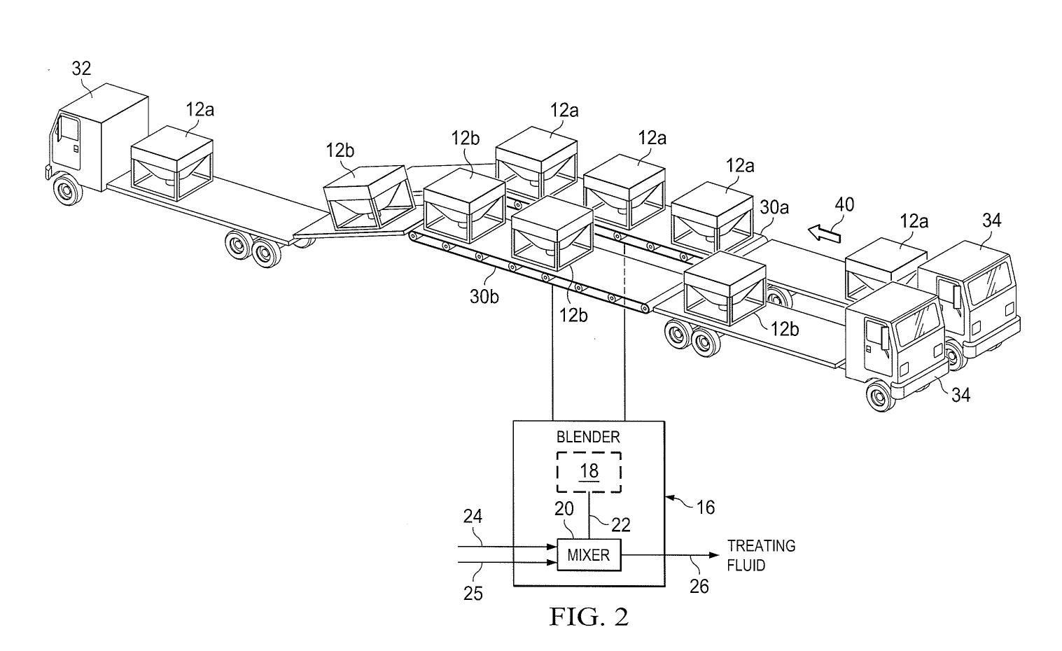

The containers 12 may be positioned in a side-by-side arrangement as illustrated in FIG. 2 with containers 12a and 12b. The containers 12 may be replaceable such that once the bulk material from one container 12 runs low, the empty container is moved off conveyor 30 and placed on a transportation unit (e.g., truck) 32, which carries away the empty containers for subsequent refilling offsite. Transportation unit(s) 34 is provided for delivering full containers 12 on one end of the conveyor 30, while transportation unit 32 is provided at the other end for receiving the empty containers. The transportation units 32, 34 can continuously supply containers 12 full of bulk material via the conveyor 30 to the blender 30, such that a continuous supply of bulk material is delivered in to the blender 16.

As shown in FIG. 2, the two conveyors 30a and 30b may be positioned side-by-side over the blender 16 so that two containers 12a and 12b may be placed over the blender at a time. This arrangement can double the rate at which bulk material is being delivered to the blender 16. Each container 12a and 12b may hold the same type, particle size, and/or material of bulk material in some embodiments. In other embodiments, the containers 12a and 12b may hold different types, particle sizes, and/or materials of bulk material, to provide a desired treating fluid for the treating process being performed. For example, when performing fracturing operations, it may be desirable to initially pump a treating fluid having smaller proppant particles downhole, to start opening perforations formed within the well. After this, the fracturing treatment may proceed to pumping a treating fluid with large proppant particles downhole, to expand the openings in the perforations. The large proppant particles may be supplied from one container (e.g., forward container 12b) after the smaller proppant particles are used from the other container (e.g., rear container 12a). As those of ordinary skill in the art will appreciate, while only two conveyors 30a and 30b are shown disposed side-by-side over the blender 16, additional conveyors carrying additional containers may be arranged over the blender 16.

Transportation units 34 may be provided at the well site for storing one or more additional containers 12 of bulk material to be used at the site. Multiple transportation units 34 may act as a bulk storage system at the well site for holding large quantities of containers in reserve for use at the well. Before a treatment begins, one or more containers 12 of bulk material may be transferred from the transportation units 34 to conveyors 30a and 30b, as indicated by the arrow 40. This transfer may be performed by lifting the container 12 via a hoisting mechanism, such as a forklift or a crane or by sliding the containers off the back of the transportation units 34 directly onto the conveyors 30a and 30b via wheels attached to the containers 12 or the platform of the transportation units 34. Alternatively, the transportation units 34 themselves may be equipped with their own conveyors thereby permitting conveyor-to-conveyor transfer of the containers 12 from the transportation units 34 to the conveyors 30.

After one or more of the containers 12a and 12b on the conveyors 30a and 30b are emptied, the empty container(s) may be removed by advancing the conveyor(s) so as to move the empty container(s) to an empty transportation unit 32 used to haul the empty containers 12 away. In some embodiments, the one or more empty containers 12 may be positioned on a skid, a pallet, or some other holding area until they can be removed from the well site and/or refilled. In other embodiments, the one or more empty containers 12 may be positioned directly onto the empty transportation unit 32 for transporting the empty containers 12 away from the well site as shown by arrow 42. It should be noted that the same transportation unit 32/34 used to provide one or more filled containers 12 to the well site may then be utilized to remove one or more empty containers from the well site.

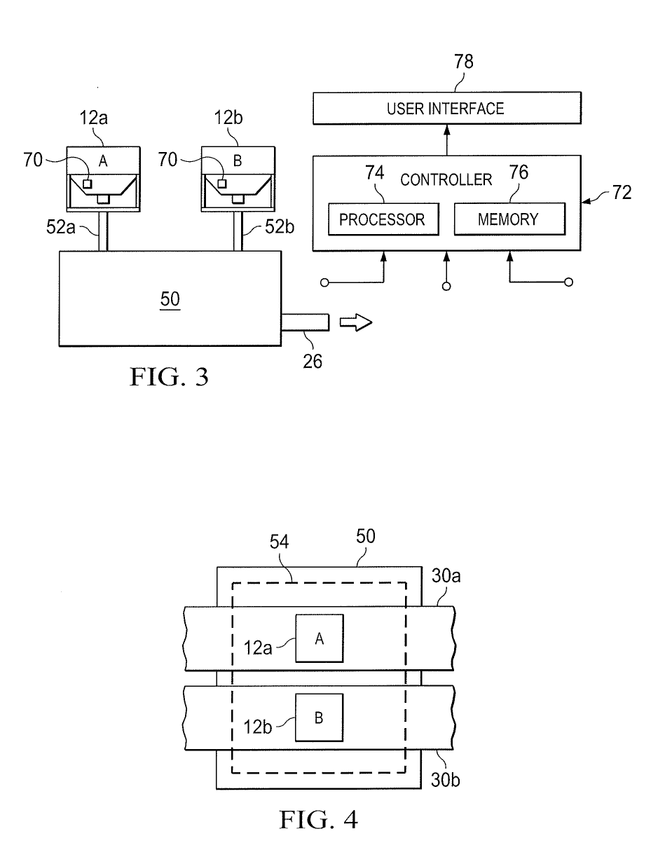

FIGS. 3 and 4 provide an enlarged view of the embodiment of the containers 12a and 12b in the side-by-side configuration holding bulk material and disposed above a blender receptacle 50 (e.g., hopper or mixer) associated with a blender. As illustrated, several conveyors 30a and 30b disposed over the blender receptacle 50 deliver multiple containers 12a and 12b to the blender receptacle and enable the delivery of bulk material into the blender receptacle 50. The conveyors 30a and 30b may be elevated so that the containers 12 are disposed above the blender receptacle 50 when they are dispensing bulk material into the blender receptacle 50. Each container 12a and 12b may include a chute 52a and 52b extending from the lowest part of the container, to dispense bulk material from the containers directly into the blender receptacle 50.

The term “blender receptacle” used herein may refer to any number of tubs, hoppers, mixers, and other areas where bulk material is needed. As mentioned above, the blender receptacle 50 may be associated with a blender disposed at the well site. For example, the blender receptacle 50 may be a blender hopper (e.g., hopper 18 of FIG. 1) used to provide bulk material to a metering system that meters the bulk material into a mixer. In other embodiments, the blender receptacle 50 may be a mixing tub (e.g., mixer 20 of FIG. 1) of a blender. In such instances, the blender receptacle 50 (mixer) may be configured such that it is sitting directly on the ground, instead of in an elevated position within the blender. This may enable the containers 12 to dump bulk material directly into the mixer, without the containers being elevated exceedingly high. In still other embodiments, the blender receptacle 50 may be a mixer feeder (e.g., conveyor, sand screw, or the metering mechanism 22 of FIG. 1). Other embodiments of the system 10 may utilize other types of blender receptacles 50 for receiving the bulk material from the disclosed containers 12.

As illustrated in FIGS. 3 and 4, the containers 12 may be arranged in a side-by-side configuration above blender receptacle 50 when delivering bulk material to the top of the blender receptacle. In some embodiments, each container 12 when filled to maximum capacity may hold approximately one small tank truck load of bulk material. To accommodate this amount of bulk material capacity, each of the containers 12 may have an internal volume of up to approximately 14 cubic meters for holding bulk material. In other embodiments, however, the containers 28 used in the container stacks 12 may hold a smaller or larger amount of bulk material than a tank truck.

Each of the containers 12 disposed above the blender receptacle 50 may provide a gravity feed of bulk material into the blender receptacle 50. That is, the bulk material is moved from the containers 12 into the blender receptacle 50 via gravity, instead of on a conveyor. This may keep the bulk material from generating a large amount of dust, since the bulk material is flowing into the blender receptacle 50 instead of falling into the tub (which would cause air entrainment of the dust) as more capacity within the blender receptacle 50 becomes available.

The containers 12a and 12b may utilize a choke-feed mode to meter the bulk material into the blender receptacle 50. Also, as noted above, the chutes 52a and 52b may extend from the containers 12a and 12b, respectively, to the blender receptacle 50 such that additional bulk material is discharged from the chutes 52a and 52b at a fill level of the bulk material already present in the blender receptacle 50. When an outlet valve or dumping mechanism on the containers 12 are actuated, the top of the chutes 52 may be opened and kept open while the chutes fills the blender receptacle 50. The bulk material may travel down the chutes 52 and be discharged into the blender receptacle 50 under a force due to gravity working on the bulk material. In embodiments where solid bulk material is used, an angle of repose of the bulk material in the blender receptacle 50 may affect the flow rate of material from the chutes 52.

In some embodiments, the containers 12a may hold a first type, particle size, or material of bulk material (A), while the containers 12b may hold a second type, particle size, or material of bulk material (B). The bulk material A may be the same or different from the bulk material B. As the container 12a outputs the bulk material A into the blender receptacle 50, the bulk material B may be dispensed from container 12b into the blender receptacle 50 via chute 52b. Once all the bulk material A is dispensed from the container 12a into the blender receptacle 50, another container 12a is delivered along conveyor 30a to the dispensing region 54, which is located just above the top of the blender receptacle 50. The conveyors 30 are designed such that the bulk material is permitted to flow out of the containers 12 into the blender receptacle 50. Accordingly, in at least one embodiment therefore, they are formed by a pair of parallel open rails in the dispensing region 54. In such an embodiment, the containers 12 are at least formed of rails at their bottom surface which can ride along the rails forming the conveyor. Structures such as wheels can incorporated either into the rails of the conveyor 30 or the rails on the containers 12 or both in such an embodiment. As those of ordinary skill in the art will appreciate, other configurations of the conveyors 30 and containers 12 may be employed to enable the containers to move laterally while at the same time dispense their load into the blender receptacle 50.

It may be desirable, in some instances, to arrange the containers 12 in a desired order so that a desired bulk material is provided to the blender receptacle 50 at a certain time. Also, it may be desirable to arrange the containers 12 so that all they are designed to output the same bulk material into the blender receptacle 50 at the same time.

Arranging the containers 12 along one or more parallel conveyors 30 may enable a more efficient use of space at the well site. This arrangement may also enable the transportation units 32, 34 to more efficiently maneuver through the well site, as they only need to park on two sides of the blender receptacle 50 to provide new containers 12 to receive empty containers that are being removed from the conveyors 30.

The containers 12 described above may be any desirable shape. For example, the containers 12 may be squared (as shown in FIGS. 1-4), rounded (not shown), cylindrical, oblong, oval, slightly bowed, or any other desirable shape. The containers 12 may be a “dump” type of container with one or more hatches at the bottom designed to automatically open in a manner that dumps the bulk material out of the container 12. The “dump” type of containers 12 may also include one or more operable gates on the bottom of the containers 12 designed to be opened/closed to dump the bulk material.

In some embodiments, the containers 12 may include one or more Super Sack® containers. When using these types of containers 12, the automatic dumping may be achieved by moving the sack across a sharp blade. Once the bulk material is transferred therefrom, the empty sacks may be removed by the conveyors 30 and deposited in a trash bin or otherwise removed off the well site. In other embodiments, the containers 12 may include one or more reusable sacks with a relatively stronger construction that enables the sacks to be refilled off location. That way, the sacks can later be returned to and re-used as containers 12. These reusable sacks may be constructed as larger than existing Super Sacks and designed so they can be filled from the top and emptied out of the bottom.

In some embodiments, the containers 12 may be partially or fully enclosed to guard the bulk material against the elements (e.g., sun, rain, and other weather). The containers 12 may be equipped with additional side walls disposed around the internal volume of the containers 12, for aesthetic reasons as well as to enable easier cleanup after the container 12 is emptied and removed from the conveyors 20. That is, any dust generated from within the internal volume of the container 12 may be contained within the additional side walls and enclosed portions and then subsequently removed or filtered, to prevent undesirable dust accumulation outside the container 12. In some embodiments, the containers 12 may be constructed with one or more coupling mechanisms (e.g., hooks, latches, slots) to enable engagement between the container 12 and a hoisting mechanism (e.g., crane, forklift, etc.) used to handle movement of the container 12.

Bulk material inventory tracking may be generally desired at the well site. As shown in FIG. 3, such bulk material inventory tracking may be accomplished through a number of different sensors 70 disposed about the well site. These sensors 70 may be communicatively coupled to one or more controllers 72 (e.g., automated control system), which utilize at least a processor component 74 and a memory component 76 to monitor and/or control inventory at the well site. For example, one or more processor components 74 may be designed to execute instructions encoded into the one or more memory components 76. Upon executing these instructions, the processors 74 may provide passive logging of the amount, type, and location of certain bulk materials at the well site. In some embodiments, the one or more processors 74 may execute instructions for controlling the amount, type, and location of bulk materials that are being transported about the well site. For example, the processors 74 may output signals at a user interface 78 for instructing operators to remove an empty container 12 from a conveyor 30 and replace the container 12 with a new container 12 holding a certain type of bulk material needed for the well treatment. Other types of instructions for inventory control/monitoring may be provided through the disclosed systems.

As noted above, the inventory control system 72 may include a number of different sensors 70. In some embodiments, these sensors 70 may include one or more load cells or bin full switches for tracking a level of bulk material in a container 12 and indicating whether a container 128 is empty, full, or partially full. Such sensors 70 may be used for any given container 12, the blender receptacle 50, a silo (not shown), or any other component at the well site. In addition, in some embodiments the sensors 70 may include RFID tags used to provide an indication of the particle size, bulk volume, weight, type, material, and/or supplier of the bulk material disposed in a certain container 12. In such instances, the controller 72 may be communicatively coupled to an RFID reader disposed in proximity to the containers 12 being moved about the well site.

In some embodiments, the containers 12 may include one or more electronic sensors 70 used to determine and indicate whether the container 12 is full or empty. As noted above, such electronic sensors 70 may be communicatively coupled (e.g., wirelessly) to an automated control system 72. The sensors 70 may instruct the system 10 or operators to proceed to the next available container when an “empty” or “nearly empty” signal is detected. In other embodiments, the containers 12 may be equipped with a mechanical sensor or mechanical indicator for indicating whether the container 12 is full or empty.

It may be particularly desirable for the containers 12a and 12b of FIG. 2 to be equipped with sensors 70 for detecting whether the container are full or empty. Once one of the containers 12a, 12b is empty, an operator may receive an instruction from the automated control system 72 to remove and replace the empty container 12a or 12b with a new, full container. By constantly monitoring the level of the containers 12a/12b, the system and ensure that the blender receptacle 50 is receiving a near continuous stream of bulk material from both containers. This additional bulk material capacity may enable the well treatment operations to continue as desired while operators are reloading the conveyors 30a/30b with full containers 12.

As described above, the disclosed system utilizes several relatively small, independent containers 12 to hold the bulk material needed for a well treatment, instead of a pneumatically filled silo. This arrangement of individual containers 12 may provide relatively easy methods for transporting the bulk material around the well site. For example, the containers 12 may enable quick unloading of a transportation unit and quick loading/re-loading of the conveyors 30 using a forklift, conveyor on the transportation unit, or other moving or hoisting mechanism. This type of unloading/loading may be accomplished more efficiently than a pneumatic loading process. In addition, the containers 12 may be quickly pushed out of the way and removed from the conveyors 30 once emptied. The smaller volumes of bulk material provided in the containers 12 may enable a relatively rapid change of the type of bulk material delivered to the blender receptacle 50, allowing for quick customization of the well treatment. The multiple containers 12 (particularly when arranged in parallel tracks 30a and 30b feeding into the same blender receptacle 50) may provide a buffer for bulk material delivery so that the blender receptacle 50 is constantly being supplied with bulk material while transportation units are arriving and being unloaded at the well site. Furthermore, once the treatments are completed at the well site, any remainder of filled containers 12 may be easily transported off location.

By making the bulk material unloading/loading process on location more efficient, the disclosed techniques may reduce the detention costs accrued at the well site, since transportation units may be able to unload their materials faster than would be possible using pneumatics. In addition, the disclosed techniques may enable the transfer of bulk material on location without generating excessive noise that would otherwise be produced through a pneumatic loading process. Still further, the bulk material remains in the individual containers 12 until it is output directly into the blender receptacle 50 via the corresponding chutes 52. Since the bulk material remains in the containers 12, instead of being released directly onto a conveyor, the containers 12 may enable movement of bulk material on location without generating a large amount of dust.

Although the present disclosure and its advantages have been described in detail, it should be understood that various changes, substitutions and alterations can be made herein without departing from the spirit and scope of the disclosure as defined by the following claims.

What is claimed is:

1. A system, comprising:
a blender receptacle associated with a blender;
a container disposed proximate the blender receptacle and holding bulk material;
a chute extending downward from the container for routing the bulk material from the container into the blender receptacle; and
a conveyor on which the container may be delivered proximate to the blender receptacle.

2. The system of claim 1, wherein the blender receptacle comprises a mixing compartment of the blender where the bulk material is mixed with additives to generate a treatment fluid.

3. The system of claim 1, wherein the blender receptacle comprises a hopper disposed on the blender for routing the bulk material to a mixing compartment.

4. The system of claim 1, further comprising one or more sensors disposed on the container for tracking a level of bulk material.

5. The system of claim 4, further comprising a user interface connected to a controller which communicates with the one or more sensors to notify an operator to remove and replace the container.

6. The system of claim 1, wherein the container comprises a square, round, cylindrical, oblong, oval, or sack shaped body.

7. A system, comprising:
a blender receptacle associated with a blender;
a first container disposed proximate the blender receptacle and holding bulk material;
a first chute extending downward from the first container for routing the bulk material from the first container into the blender receptacle;
a second container holding bulk material, wherein the second container is disposed adjacent to the first container; and
a second chute extending downward from the second container for routing the bulk material from the second container into the blender receptacle.

8. The system of claim 7, wherein the first and second containers each hold the same type of bulk material.

9. The system of claim 7, wherein the first and second containers each hold a different type of bulk material.

10. The system of claim 7, wherein the first container is shaped to provide a choke feed for the bulk material output from the first container to the first chute and the second container is shaped to provide a choke feed for the bulk material output from the second container to the second chute.

11. The system of claim 7, further comprising one or more sensors disposed on the first container for tracking a level of bulk material in the first container and one or more sensors disposed on the second container for tracking a level of bulk material in the second container.

12. The system of claim 11, further comprising a user interface connected to a controller which communicates with the one or more sensors on the first and second containers to notify an operator to remove and replace the first and second containers.

13. The system of claim 7, wherein the first and second containers both comprise a square, round, cylindrical, oblong, oval, or sack shaped container.

14. A method, comprising:
dispensing bulk material from a first container through a first chute extending from the first container directly into a blender receptacle associated with a blender; and
dispensing bulk material from a second container through a second chute disposed adjacent to the first container directly into the blender receptacle.

15. The method of claim 14, further comprising removing and replacing the first and second containers when they are empty of bulk material or when material of a different type is desired.

16. The method of claim 15, further comprising tracking a level of bulk material in the first and second containers via one or more sensors.

17. The method of claim 15, further comprising removing and replacing the first container via a first conveying mechanism and removing and replacing the second container via a second conveying mechanism.

18. The method of claim 17, further comprising delivering the first and second containers to the conveying mechanisms via one or more transportation units.

19. The method of claim 14, further comprising mixing the bulk material dispensed into the blender receptacle with additives to generate a treatment fluid within the blender receptacle.

20. The method of claim 14, further comprising routing the bulk material dispensed into the blender receptacle from the blender receptacle to a mixer of the blender via a metering device.
